(19) United States
(12) Patent Application Publication
(10) Pub. No.: US 2007/0016576 A1
(43) Pub. Date: Jan. 18, 2007

(54) Method and apparatus for blocking objectionable multimedia information

(75) Inventors: Chi Yoon Jeong, Daejeon-city (KR); Seung Wan Han, Gwangjoo-city (KR); Su Gil Choi, Busan-city (KR); Taek Yong Nam, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/397,581

(22) Filed: Apr. 3, 2006

(30) Foreign Application Priority Data
Jul. 13, 2005 (KR) 10-2005-0063266

(51) Int. Cl. G06F 17/30

(52) U.S. Cl. 707/5

(57) ABSTRACT

A method and apparatus for blocking harmful multimedia information are provided. The apparatus for blocking harmful multimedia information includes: a harmful information classification model training unit analyzing multimedia training information whose grade of harmfulness is known in advance, extracting characteristics from the information, and then by applying machine training, generating a harmful information classification model; a harmful information grade classification unit determining a harmfulness grade of multimedia input information by using the harmful information classification model; and a harmful information blocking unit blocking the multimedia input information if the determined harmfulness grade of the multimedia input information is included in a preset range. According to the method and apparatus, the increase of databases containing harmful multimedia information can be prevented and the time taken for determining harmfulness can be reduced.

### CROSS-REFERENCE TO RELATED PATENT APPLICATIONS

This application claims the benefit of Korean Patent Application No. 10-2005-0063266, filed on Jul. 13, 2005, in the Korean Intellectual Property Office, the disclosure of which is incorporated herein in its entirety by reference.

### BACKGROUND OF THE INVENTION

1. Field of the Invention

The present invention relates to a method and apparatus for blocking harmful multimedia information, and more particularly, to a method and apparatus for blocking harmful multimedia information fast and accurately in a storage space with a less capacity by using machine training.

2. Description of the Related Art

As personal computers and the Internet connections have been increasingly widely used recently, use of network-based services, such as World Wide Web (hereinafter referred to as ‘web’), file transfer protocols, and email, has been continuously increasing.

In particular, the Internet includes a variety of information items such that it is called the sea of information, and provides easiness to use. Accordingly, the Internet has become part of living of many people, including children, and provided positive effects in social, economical, and academic aspects. However, in contrast to the positive aspects, harmful information indiscreetly distributed by using the characteristics of the openness, interconnectivity, and anonymity of the Internet has been emerging as a serious social problem. Especially, it may have bad effects emotionally to children who are lacking in value judgement. Accordingly, a method of blocking harmful information is needed in order to prevent children who are socially weak people, or those who do not want the harmful information, from being exposed to the harmful information.

The conventional technologies for blocking harmful multimedia information distributed through the Internet determine the harmfulness, by analyzing mainly the address of the Internet, or the representative names and storage locations that are additional information of transmitted data, irrespective of the contents of the information. Here, the main part of the methods of determining harmfulness used in the conventional technologies includes direct comparison methods, by which names of harmful information, and storage locations of harmful information are stored in a database, and then multimedia information suspected of being harmful is compared with the information stored in the database, and indirect comparison methods using abbreviated characteristic values.

However, since these methods cannot reflect the contents of the harmful information, the blocking ratio of harmful information is low and harmless information can be blocked. To solve this problem, a method of determining harmfulness by comparing the contents of information distributed on the Internet with a database of harmful information has been suggested. However, in the method of determining harmful information relying on the database of harmful information, the size of the database continues to increase as the amount of harmful information increases, and with the increasing size of the database, the time taken for determining harmful information also increases.

In order to avoid this problem, a method of maintaining a database storing only harmful information that has a representative characteristic has been suggested. According to the method, characteristics are extracted from harmful multimedia information and a database of the extracted harmful information characteristics is established so that harmfulness can be determined. However, since this method uses the database of harmful information for determining harmfulness, the size of the database continues to increase endlessly as the amount of harmful information increases, and in addition, with the increasing size of the database, the time taken for determining harmful information also increases. Also, since selection of harmful information having a representative characteristic is artificially performed, the real representative characteristic of the selected harmful information cannot be guaranteed. Furthermore, because of the characteristic of multimedia that is expressed differently in computers though it is shown similarly to human eyes, harmful information selected by a human being has a weaker representative characteristic such that the performance of classifying harmful information is lowered.

### SUMMARY OF THE INVENTION

The present invention provides a method and apparatus by which MPEG-7 characteristics and non-standard characteristics are extracted from multimedia training information, and machine training in relation to the extracted characteristics is performed to generate a harmful information classification model reflecting the common characteristic of harmful information, and by using the generated harmful information classification model, the harmfulness grade of input multimedia information is classified and blocked.

The present invention also provides a method and apparatus by which harmfulness grade classification of input multimedia information is performed not relying on an already established harmful information database, but through a harmful information classification model that is a machine training result in relation to common characteristics of multimedia training information, and through retraining using harmful information classification results, an adaptive harmful information classification model is generated so that input multimedia information is effectively blocked.

According to an aspect of the present invention, there is provided an apparatus for blocking harmful multimedia information including: a harmful information classification model training unit analyzing multimedia training information whose grade of harmfulness is known in advance, extracting characteristics from the information, and then by applying machine training, generating a harmful information classification model; a harmful information grade classification unit determining a harmfulness grade of multimedia input information by using the harmful information classification model; and a harmful information blocking unit blocking the multimedia input information if the determined harmfulness grade of the multimedia input information is included in a preset range.

According to another aspect of the present invention, there is provided a method for blocking harmful multimedia information including: analyzing multimedia training information whose grade of harmfulness is known in advance, extracting characteristics from the information, and then by applying machine training, generating a harmful information classification model; receiving the generated harmful information classification model transmitted and determining a harmfulness grade of the multimedia input information being input; and blocking the multimedia input information if the determined harmfulness grade of the multimedia input information is included in a preset range.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for blocking harmful multimedia information according to a preferred embodiment of the present invention;

FIG. 2 is a block diagram of more detailed structures of a harmful information classification model training unit and a harmful information classification model of FIG. 1;

FIG. 3 is another block diagram of more detailed structures of a harmful information classification model training unit and a harmful information classification model of FIG. 1;

FIG. 4 is a block diagram of a more detailed structure of a harmful information grade classification unit of FIG. 1;

FIG. 5 is another block diagram of a more detailed structure of a harmful information grade classification unit of FIG. 1;

FIG. 6 illustrates transmission of result information through feedback by a harmful information blocking unit to a harmful information classification model training unit of FIG. 1; and

FIG. 7 is a flowchart of a method of blocking harmful multimedia information according to a preferred embodiment of the present invention.

### DETAILED DESCRIPTION OF THE INVENTION

The present invention will now be described more fully with reference to the accompanying drawings, in which exemplary embodiments of the invention are shown.

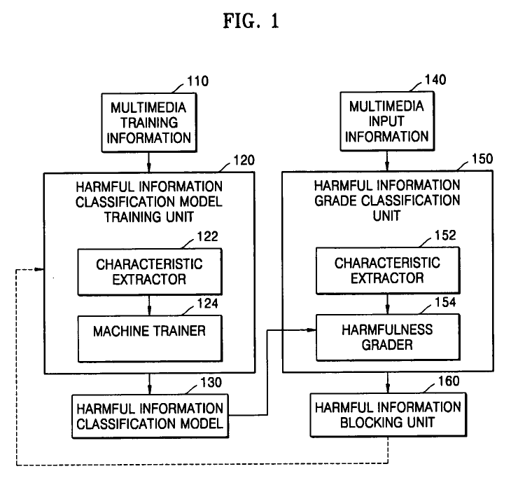

Referring to FIG. 1, an apparatus for blocking harmful multimedia information according to a preferred embodiment of the present invention includes a harmful information classification model training unit 120, a harmful information grade classification unit 150, and a harmful information blocking unit 160. The harmful information classification model training unit 120 includes a characteristic extractor 122 and a machine trainer 124, and the harmful information grade classification unit 150 includes a characteristic extractor 152 and a harmfulness grader 154.

The characteristic extractor 122 of the harmful information classification model training unit 120 receives inputs of multimedia training information 110 whose harmfulness degree (grade) is known in advance. By analyzing the multimedia training information 1 10, the characteristic extractor 122 of the harmful information classification model training unit 120 extracts MPEG-7 characteristics and non-standard multimedia characteristics, and thus extracted characteristics is trained by the machine trainer 124. As the result of the training, the harmful information classification model 130 reflecting the common characteristics of harmful information is generated.

Here, the present invention does not use a method of determining harmfulness based on a database, but uses a method of determining harmfulness of multimedia based on machine training using the machine trainer 124. That is, in determining harmfulness of multimedia information, the database of harmful multimedia information is not used, but the harmful information classification model is used. To obtain the model, characteristics of multimedia training information whose harmfulness degree is known in advance are extracted and the extracted characteristics are trained by the machine trainer 124. By doing so, the harmful information classification model is obtained.

Unlike the conventional method of determining harmfulness based on the database, if the harmful information classification model reflecting the representative and common characteristics of harmful information is used, the amount of information to be compared with and the size of the classification model do not increase even though the harmful multimedia information increases, and the determination ratio of harmfulness in relation to a similar type of harmful multimedia information newly appearing is high.

Also, compared to the database-based harmfulness determination method, the time taken for determining harmfulness is reduced.

Furthermore, in relation to a more variety of types of input multimedia information, machine training is performed, harmfulness is determined, and a threshold value is automatically determined. Accordingly, compared to the conventional method determining a threshold manually, the present embodiment has an improved ability to determine harmfulness.

The generated harmful information classification model 130 is used by the harmfulness grader 154 of the harmful information grade classification unit 150 in order to determine the harmfulness grade of the multimedia input information 140. At this time, as the input of the harmfulness grader 154, the multimedia input information 140 is not directly used, but the MPEG-7 characteristics and non-standard multimedia characteristics of the multimedia input information 140 extracted by the characteristic extractor 152 of the harmful information grade classification unit 150 are used.

The harmful information blocking unit 160 blocks the multimedia input information 140 according to the grade determination result of the harmfulness grader 154.

More specifically, the harmful information blocking unit 160 determines the blocking of the harmful multimedia input information according to whether or not the harmfulness grade of the multimedia input information, received from the harmful information grade classification unit 150 is included in an already set range.

Also, in order to improve the performance of the harmful information classification model 130, the harmful information blocking unit 160 feeds the result information of the harmful information blocking back to the harmful information classification model training unit 120 so that retraining can be performed. Since the retraining using this feedback can generate an adaptive harmful information classification model 130, the performance of harmful multimedia input information classification can be continuously improved.

As described above, the characteristic extractor 122 of the harmful information classification model training unit 120 analyzes the multimedia training information 110 whose harmfulness grade is known in advance, and extracts multimedia characteristics and non-standard multimedia characteristics that can represent the contents of respective multimedia. More specifically, the MPEG-7 characteristics as the multimedia characteristics, and non-standard MPEG-7 characteristics as the non-standard multimedia characteristics, are extracted. The MPEG-7 characteristics are abbreviated expression forms obtained by abbreviating images and moving pictures that are defined by the moving picture experts group (MPEG) for convenient retrieval of multimedia data. For example, in case of an image, color, texture, and shape can be characteristics. The non-standard MPEG-7 characteristics indicate all other characteristics than defined in the MPEG-7.

As characteristics of multimedia that can be extracted, MPEG-7 descriptors that are international standards can be used, and descriptors that are used to express the contents of multimedia can be used as non-standard multimedia characteristics.

The MPEG-7 descriptor is expressed as a number vector by extracting an MPEG-7 characteristic from input data, and indicates a specific value of the MPEG-7 characteristic.

More specifically, for example, in case of original image data, each pixel of the image has all of red, green, and blue values. If the characteristic of the color from the original image is extracted and the image data is expressed by only three numbers, such as the average of R values, the average of G values, and the average of B values, the MPEG-7 characteristic is the color and the MPEG-7 descriptors are the averages of the R values, G values, and B values.

The characteristics extracted from multimedia information, including multimedia training information and multimedia input information, have a variety of types, including voice, image and moving picture information. One characteristic extracted from these is expressed as the following equation 1:
Fᵢ=(fᵢ₁, fᵢ₂, fᵢ₃, . . . , fᵢₙ₋₁, fᵢₙ) (1)
Here, Fᵢ denotes one characteristic value (i) such as voice, image and moving picture information in relation to arbitrary multimedia information, and has n elements.

Characteristic F used to classify harmfulness grades can be formed with m characteristic values. If it is assumed that each characteristic value is formed with n elements (though each characteristic value has a different number of elements, but for convenience of expression, it is assumed here that each characteristic value has the same number of elements), the characteristic F is expressed in the form of a matrix m×n, and can be expressed in the form of (m×n)×1 as the following equation 2:
F=(f₁₁, f₁₂, . . . , f₁ₙ, f₂₁, f₂₂, . . . f₂ₙ, . . . , fₘ₁, fₘ₂, . . . , fₘₙ) (2)
The characteristic F as shown above is used as an input value of the machine trainer 124 in order to generate the harmful information classification model 130 or as an input value of the harmfulness grader 154 of the harmful information grade classification unit 150 in order to determine a harmfulness grade.

The characteristic F extracted from the multimedia training information 110 by the characteristic extractor 122 is used as an input value of the machine trainer 124, and the machine trainer 124 receives the input F and generates a classification model capable of distinguishing the grade of harmful information.

A classification model can be expressed as the following equations 3 and 4:

$$\begin{matrix}{D}_{i} = {\sum }_{j = 1}^{k} {w}_{j} d ( {M}_{ij} , F ) + {ɛ}_{j} & ( 3 ) \\ C = max ( {D}_{i} ) & ( 4 )\end{matrix}$$

In equation 3, Mᵢⱼ denotes a grade boundary vector forming classification model C, d(Mᵢⱼ, F) denotes a difference value between a grade boundary vector and characteristic F, wⱼ denotes a weight value, εⱼ denotes a correction value, and Dᵢ denotes a score that the characteristic F of the multimedia training information 110 corresponds to a predetermined grade i (harmless or harmful). Here, the bigger Dᵢ is, the higher the probability that the characteristic F belongs to grade i is. The harmful information classification model 130 obtained through machine training is transferred to the harmful information grade classification unit 150 and used for determining a harmfulness grade of multimedia input information.

The characteristic extractor 152 of the harmful information grade classification unit 150 extracts the characteristic F as the equation 2, from the multimedia input information 140, and the harmfulness grader 154 inputs the characteristic F to the received harmful information classification model 130 and calculates the value of Dᵢ as the equation 3. The multimedia input information 140 is determined to have grade C having the highest value of Dᵢ as in the equation 4. If the determined grade belongs to a harmful grade, the multimedia input information 140 is blocked by the harmful information blocking unit 160.

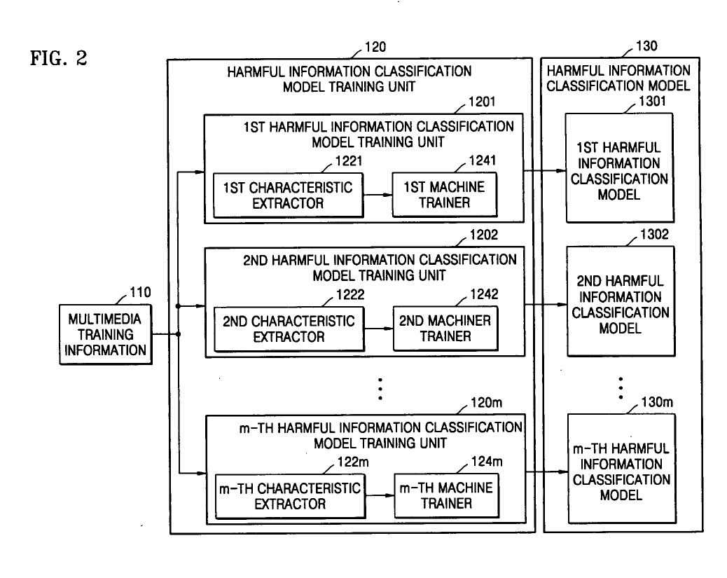

FIG. 2 is a block diagram of more detailed structures of a harmful information classification model training unit and a harmful information classification model of FIG. 1. Referring to FIG. 2, the multimedia training information 110 is used as an input of the harmful information classification model training unit 120 formed with a plurality of harmful information classification model training units, and a plurality of harmful information classification models 130 are generated. The harmful information classification model training units 120 generate their respective harmful information classification models 130, by using independent characteristic extractors and machine trainers for the multimedia training information 110.

More specifically, the first harmful information classification model training unit 1201 generates a first harmful information classification model 1301 by using an independent first characteristic extractor 1221 and first machine trainer 1241 in relation to the multimedia training information 110. The second harmful information classification model training unit 1202 generates a second harmful information classification model 1302 by using an independent second characteristic extractor 1222 and second machine trainer 1242 in relation to the multimedia training information 110.

Also, the m-th harmful information classification model training unit 120m generates an m-th harmful information classification model 130m by using an independent m-th characteristic extractor 122m and m-th machine trainer 124m in relation to the multimedia training information 110.

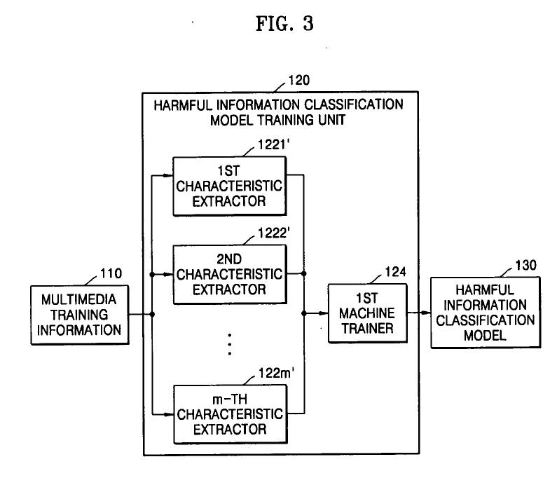

FIG. 3 is another block diagram of more detailed structures of a harmful information classification model training unit and a harmful information classification model of FIG.1. Referring to FIG. 3, the multimedia training information 110 is used as an input of one harmful information classification model training unit 120 and one harmful information classification model 130 is generated. The harmful information classification model training unit 120 can use a plurality of characteristic extractors 1221′, 1222′, . . . , 122m′ in order to extract a variety of characteristics from the multimedia training information 110, and the characteristics extracted from the plurality of characteristic extractors 1221′, 1222′, . . . , 122m′ are used as inputs of one machine trainer 124 and one harmful information classification model 130 is generated.

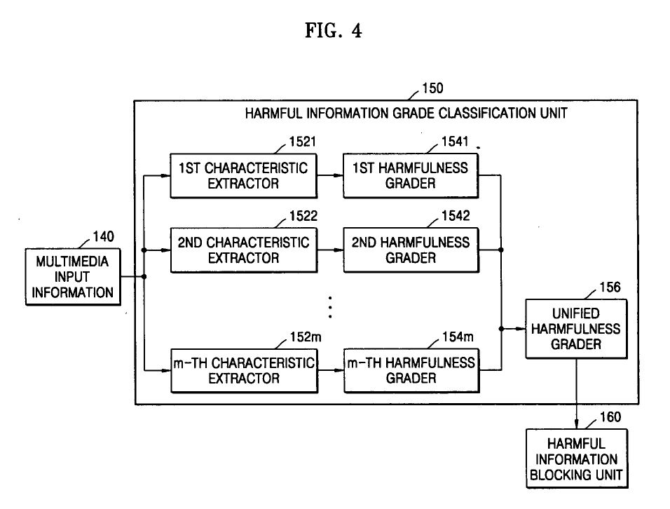

FIG. 4 is a block diagram of a more detailed structure of a harmful information grade classification unit of FIG. 1. Referring to FIG. 4, the multimedia input information 140 is transferred to the harmful information grade classification unit 150 and by a first characteristic extractor 1521, a second characteristic extractor 1522, . . . , and an m-th characteristic extractor 152m, characteristics F as the equation 2 are extracted. A first harmfulness grader 1541, a second harmfulness grader 1542, . . . , and an m-th harmfulness grader 154m receive characteristics F as inputs, and values Dᵢ as the equation 3 and grades C as the equation 4 are calculated. Grade C that is the result of the first harmfulness grader 1541, second harmfulness grader 1542, . . . , and m-th harmfulness grader 154m is transferred to a unified harmfulness grader 156, and the unified harmfulness grader 156 determines final grade C according to a policy defined in advance. Here, the first characteristic extractor 1521, second characteristic extractor 1522, . . . , and m-th characteristic extractor 152m of the harmful information classification unit 150 of FIG. 4 should be identical to the first characteristic extractor 1221, second characteristic extractor 1222, . . . , and m-th characteristic extractor 122m forming the harmful information classification model training unit 120 of FIG. 2. Also, the first harmfulness grader 1541, the second harmfulness grader 1542, . . . , and the m-th harmfulness grader 154m should receive and use the first harmful information classification model 1301, the second harmful information classification model 1302, . . . , and the m-th harmful information classification model 130m, respectively, of FIG. 2.

If the final grade C is determined as a harmful grade by the unified harmfulness grader 156, the multimedia input information 140 is blocked by the harmful information blocking unit 160.

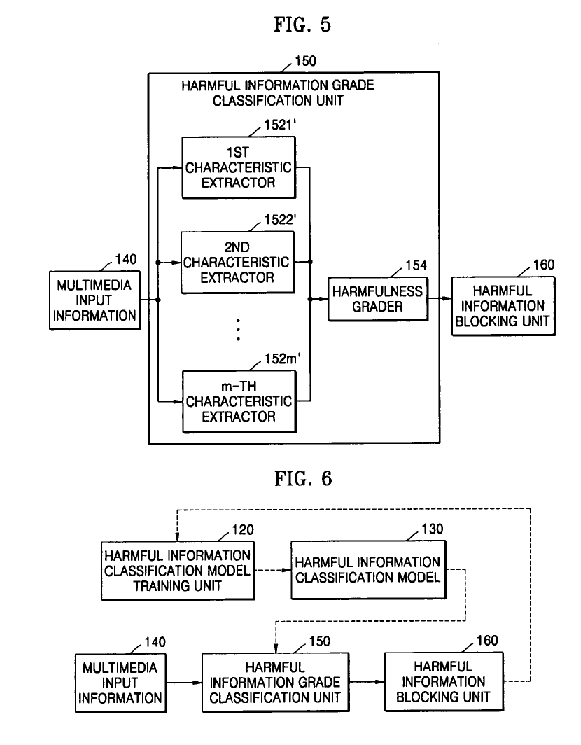

FIG. 5 is another block diagram of a more detailed structure of a harmful information grade classification unit of FIG. 1. Referring to FIG. 5, from the multimedia input information 140, the characteristic F as the equation 2 is extracted by the first characteristic extractor 1521, second characteristic extractor 1522, . . . , and m-th characteristic extractor 152m of the harmful information classification unit 150, and values Dᵢ as the equation 3 and grades C as the equation 4 are determined by the harmfulness grader 154.

Here, the first characteristic extractor 1521, second characteristic extractor 1522, . . . , and m-th characteristic extractor 152m of the harmful information classification unit 150 of FIG. 5 should be identical to the first characteristic extractor 1221′, second characteristic extractor 1222′, . . . , and m-th characteristic extractor 122m′ forming the harmful information classification model training unit 120 of FIG. 3. Also, the harmfulness grader 154 should receive the transmitted harmful information classification model 130 of FIG. 3 and use it.

If grade C is determined as a harmful grade by the harmfulness grader 154, the multimedia input information 140 is blocked by the harmful information blocking unit 160.

FIG. 6 illustrates transmission of result information through feedback by a harmful information blocking unit to a harmful information classification model training unit of FIG. 1. Referring to FIG. 6, in relation to the multimedia input information 140, the harmful information grade classification unit 150 determines whether or not the information is harmful, by using the harmful information classification model 130, and the multimedia input information 140 which is determined to be harmful is blocked by the harmful information blocking unit 160. The harmful information blocking unit 160 feeds the result back to the harmful information classification model training unit 120 such that retraining is performed. Then a new harmful information classification model 130 is generated. The newly generated harmful information classification model 130 is transferred to the harmful information grade classification unit 150 so that the model 130 is applied.

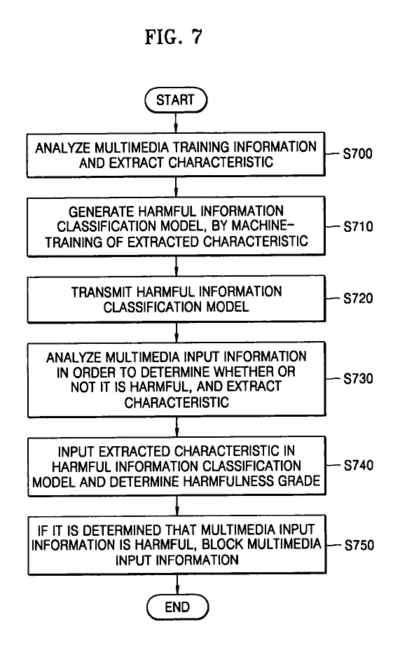

FIG. 7 is a flowchart of a method of blocking harmful multimedia information according to a preferred embodiment of the present invention. Referring to FIG. 7, first, multimedia training information whose harmfulness degree (grade) is known in advance, is analyzed and the characteristics are extracted in operation S700. Here, the characteristics include the MPEG-7 characteristics and non-standard characteristics.

Next, the characteristics extracted in the operation S700 are machine-trained such that a harmful information classification model is generated in operation S710. The harmful information classification model is generated as the result of training after the characteristics extracted in the operation S700 are trained through a machine trainer.

Next, the harmful information classification model generated in the operation S710 is transmitted to a place where a function for classifying harmful information grades in relation to multimedia input information in operation S720 is performed in operation S720. Here, the place in which the function for classifying harmful information grades is performed can be called a harmful information classification unit.

Next, the multimedia input information is analyzed in order to determine whether or not the information is harmful and characteristics are extracted in operation S730.

Next, the characteristics extracted in the operation S730 are input to the harmful information classification model received in the operation S720 and a harmful grade is determined in operation S740.

Next, if it is determined that the harmful grade determined in the operation S740 is included in an already set range, that is, if the multimedia input information is determined to be harmful, the multimedia input information is blocked in operation S750.

Here, in case where the multimedia input information is blocked, a feedback operation of the blocking result may be further included.

For those parts that are not explained with reference to FIG. 7, FIGS. 1 through 6 can be referred to.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the harmful multimedia information blocking method and apparatus of the present invention, machine training is used to determine whether or not multimedia information is harmful, such that the endless increase of the database of harmful information is not needed and the time taken for determining harmful information can be reduced. By doing so, even with using a storage space with a smaller capacity, harmful multimedia information can be fast and accurately classified and blocked.

Also, according to the method and apparatus for blocking harmful multimedia information, when the harmful information classification model is generated from machine training, an optimized threshold obtained from training of a variety of types of data and automatic calculation is used, such that the accuracy of determining harmful information can be improved.

Furthermore, the method and apparatus for blocking harmful multimedia information generates adaptive classification models through retraining using feedback, so that the classification performance can be continuously enhanced.

The method and apparatus for blocking multimedia information of the present invention described above can be applied to portable multimedia reproducing apparatuses (MP3, PMP, etc.), and handphones, and PDAs.

What is claimed is:

1. An apparatus for blocking harmful multimedia information comprising:
a harmful information classification model training unit analyzing multimedia training information whose grade of harmfulness is known in advance, extracting characteristics from the information, and then by applying machine training, generating a harmful information classification model;
a harmful information grade classification unit determining a harmfulness grade of multimedia input information by using the harmful information classification model; and
a harmful information blocking unit blocking the multimedia input information if the determined harmfulness grade of the multimedia input information is included in a preset range.

2. The apparatus of claim 1, wherein the characteristics extracted by analyzing the multimedia training information are multimedia characteristics and/or non-standard multimedia characteristics.

3. The apparatus of claim 1, wherein the harmful information classification model training unit comprises:
a characteristic extractor analyzing the multimedia training information and extracting characteristics; and
a machine trainer generating a harmful information classification model by machine training of the characteristics extracted from the characteristic extractor.

4. The apparatus of claim 3, wherein there are a plurality of the characteristic extractors and each of the characteristic extractors extracts characteristics corresponding to a preset method, from the multimedia training information.

5. The apparatus of claim 4, wherein there are a plurality of machine trainers and the plurality of machine trainers receive inputs from characteristics extracted from the plurality of characteristic extractors, respectively, and generates a plurality of harmful information classification models.

6. The apparatus of claim 4, wherein there is one machine trainer and the machine trainer receives inputs of the characteristics extracted from the plurality of characteristic extractors, respectively, and generates one harmful information classification model.

7. The apparatus of claim 1, wherein the harmful information grade classification unit comprises:
a characteristic extractor analyzing the multimedia input information and extracting characteristics; and
a harmfulness grader receiving the harmful information classification model transmitted, inputting the characteristics extracted by the characteristic extractor into the harmful information classification model, and determining a harmfulness grade.

8. The apparatus of claim 7, wherein there are a plurality of the characteristic extractors, and each of the characteristic extractors extracts characteristics corresponding to a preset type, from the multimedia input information.

9. The apparatus of claim 8, wherein the characteristic extractor analyzes the multimedia input information and extracts characteristics in the same manner as the multimedia training information is analyzed and the characteristics are extracted in the harmful information classification model training unit.

10. The apparatus of claim 8, wherein there are a plurality of harmfulness graders, and the plurality of harmfulness graders receive inputs of a plurality of harmful information classification models, and input the characteristics extracted from the plurality of characteristic extractors, respectively, into the plurality of harmful information classification models and determine a plurality of harmfulness grades.

11. The apparatus of claim 10, further comprising:
a unified harmfulness grader receiving inputs of the plurality of harmfulness grades and determining a final harmfulness grade.

12. The apparatus of claim 8, wherein there is one harmfulness grader and the harmfulness grader receives an input of one harmful information classification model, and inputs the characteristics extracted from the plurality of characteristic extractors, respectively, into the harmful information classification model, and determines a harmfulness grade.

13. The apparatus of claim 1, wherein the harmful information blocking unit feeds the result information on whether or not the multimedia input information is blocked, back to the harmful information classification model training unit.

14. A method for blocking harmful multimedia information comprising:
analyzing multimedia training information whose grade of harmfulness is known in advance, extracting characteristics from the information, and then by applying machine training, generating a harmful information classification model;
receiving the generated harmful information classification model transmitted and determining a harmfulness grade of the multimedia input information being input; and
blocking the multimedia input information if the determined harmfulness grade of the multimedia input information is included in a preset range.

15. The method of claim 14, wherein the characteristics extracted by analyzing the multimedia training information are multimedia characteristics and/or non-standard multimedia characteristics.

16. The method of claim 14, wherein the generating of the harmful information classification model comprises:
analyzing the multimedia training information and extracting characteristics; and
generating a harmful information classification model by machine training of the extracted characteristics.

17. The method of claim 16, wherein in the analyzing and the extracting, a plurality of characteristics are extracted according to a preset method, from the multimedia training information, and in the generating of the harmful information classification model, each of the characteristics is input and machine -trained, and a plurality of harmful information classification models are generated.

18. The method of claim 16, wherein in the analyzing and the extracting, a plurality of characteristics are extracted according to a preset method, from the multimedia training information, and in the generating of the harmful information classification model, each of the characteristics is input and machine -trained, and one harmful information classification model is generated.

19. The method of claim 14, wherein the determining of the harmful grade of the multimedia input information comprises:
receiving the generated harmful information classification model;
analyzing the multimedia input information and extracting characteristics; and
inputting the extracted characteristics into the harmful information classification model and determining the harmfulness grade of the multimedia input information.

20. The method of claim 19, wherein in the extracting of the characteristics, a plurality of characteristics are extracted from the multimedia input information according to a preset method.

21. The method of claim 20, wherein the method of extracting the characteristics is identical to the method of extracting the characteristics by analyzing the multimedia training information.

22. The method of claim 20, wherein in the receiving of the generated harmful information classification model, a plurality of generated harmful information classification models are received, and in the determining of the harmfulness grade, the characteristics is input to the plurality of harmful information classification models, respectively, and a plurality of harmfulness grades are determined.

23. The method of claim 22, further comprising after the determining of the grades:
receiving the plurality of harmfulness grades and determining a final harmfulness grade.
